(19) United States
(12) Patent Application Publication
(10) Pub. No.: US 2026/0147515 A1
(43) Pub. Date: May 28, 2026

(54) MONITORING SCREEN VIEWING IMPACT

(71) Applicant: QUALCOMM Incorporated, San Diego, CA (US)

(72) Inventors: Jyotsna Tata, Bilaspur (IN); Hargovind Prasad Bansal, Bharatpur (IN); Ravinder ARE, Hyderabad (IN); Vimal Singh, Hyderabad (IN); Rajeevalochana R, Hyderabad (IN); Hari Krishna Reddy MUNAGALA, Giddalur (IN); Praveen KANDUKURI, Chilakaluripet (IN)

(21) Appl. No.: 18/962,283

(22) Filed: Nov. 27, 2024

(51) Int. Cl. G06F 3/14; G06V 40/16; H04L 67/50; H04N 21/442

(52) U.S. Cl. CPC G06F 3/14; G06V 40/172; H04L 67/535; H04N 21/44218

(57) ABSTRACT

This disclosure provides methods, components, devices and systems for monitoring screen viewing and screen viewing impact across devices in a secure device ecosystem. Some aspects more specifically relate to monitoring a viewer's screen time across various devices in the secure device ecosystem and providing a screen impact action representing an overall measure or impact of the screen viewing time to the viewer. In some examples, negative effects of screen viewing time may be increased due to adverse environmental and physical conditions of the viewer, where the overall measure or impact of the screen viewing time is adjusted to account for these negative effects using sensor data associated with the viewer received from sensor devices.

### TECHNICAL FIELD

This disclosure relates generally to monitoring device usage in wireless communication environments, and more specifically, to monitoring screen viewing and screen viewing impact across devices in a secure device ecosystem.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication or network device in a secure device ecosystem. In some implementations, the network device includes a processing system that includes one or more processors and one or more memories coupled with the one or more processors. In some examples, the processing system is configured to cause the network device to receive screen viewing data for a viewer from at least one display device in the secure device ecosystem including a screen viewing time for the viewer, and output a screen impact action for the viewer including an adjusted screen viewing time adjusted from the screen viewing time from the screen viewing data, where the screen viewing time is adjusted using a screen impact factor for the viewer generated from sensor data associated with the viewer to represent additional impacts of screen viewing on the viewer.

In some examples, the screen viewing time includes a compiled viewing time associated with the viewer across a plurality of display devices in the secure device ecosystem. In some examples, the screen impact action includes a notification indicating a comparison between a screen viewing limit for the viewer and the adjusted screen viewing time. In some examples, the screen impact action includes a notification including a screen viewing warning when the adjusted screen viewing time is above the screen viewing limit. In some examples, the screen impact action causes a blocked screen to be displayed on a display device of the at least one display device when the adjusted screen viewing time is above the screen viewing limit.

In some implementations, the screen impact factor is generated using a viewer stress factor calculated from the sensor data associated with the viewer, where the sensor data includes biometric data for the viewer. In some implementations, the screen impact factor is generated using an ambient environment factor calculated from the sensor data associated with the viewer, where the sensor data includes environmental data of a physical environment associated with the viewer during a screen viewing session.

In some examples, the screen viewing data includes a locally measured screen viewing time for the viewer, measured at a local display device of the at least one display device. In some implementations, the sensor data includes a locally generated screen impact factor for the viewer, generated at a local sensor device of the at least one sensor device. In some implementations, where the screen viewing data includes screen viewing data for a plurality of viewers, where the sensor data includes sensor data associated with the plurality of viewers, and where the processing system is further configured to cause the network device to: select screen viewing data associated with the viewer from the screen viewing data for the plurality of viewers, and select sensor data associated with the viewer from the sensor data associated with the plurality of viewers.

In some examples, selecting screen viewing data associated with the viewer from the screen viewing data for the plurality of viewers further includes identifying the viewer in the screen viewing data using facial recognition, and calculating a screen viewing time of the viewer using one or more of: a threshold view angle of the viewer, a threshold view distance of the viewer, and a minimum screen time of the viewer.

In some implementations the processing system is further configured to cause the network device to: identify each other viewer of the plurality of viewers in the screen viewing data using facial recognition, and output a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a screen viewing time for the other viewer from the screen viewing data adjusted by the screen impact factor.

Another innovative aspect of the subject matter described in this disclosure can be implemented in a wireless communication device or device in a secure device ecosystem. The device includes a processing system that includes one or more processors and one or more memories coupled with the one or more processors. In some examples, the processing system is configured to cause the device to: receive local screen viewing data for a viewer at the device including a local screen viewing time for the viewer, and output a screen impact action for the viewer including an adjusted screen viewing time adjusted from the local screen viewing time from the local screen viewing data, where the local screen viewing time is adjusted using a screen impact factor for the viewer generated from sensor data associated with the viewer to represent additional impacts of screen viewing on the viewer.

Another innovative aspect of the subject matter described in this disclosure can be implemented in a method for screen impact monitoring by a wireless communication device or network device. The method includes receiving screen viewing data for a viewer from at least one display device in a secure device ecosystem including a screen viewing time for the viewer, and outputting a screen impact action for the viewer including an adjusted screen viewing time adjusted from the screen viewing time from the screen viewing data, where the screen viewing time is adjusted using a screen impact factor for the viewer generated from sensor data associated with the viewer to represent additional impacts of screen viewing on the viewer.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a pictorial diagram of an example secure device ecosystem.

FIG. 4 shows a pictorial diagram of example sensor devices in a secure device ecosystem arrangement.

FIG. 5 shows a pictorial diagram of example secure device ecosystem arrangement that supports monitoring screen viewing and screen viewing impact across devices for a viewer.

FIG. 6 shows a pictorial diagram of example secure device ecosystem arrangement that supports monitoring screen viewing and screen viewing impact across devices for multiple viewers.

FIG. 7 shows a pictorial diagram of example secure device ecosystem arrangement that supports identifying multiple viewers of a device and monitoring screen viewing for the multiple viewers.

FIG. 8 shows a pictorial diagram of example secure device ecosystem arrangement that supports monitoring screen viewing and screen viewing impact at a local device for a viewer.

FIG. 9 shows a pictorial diagram of an example display device in a secure device ecosystem.

FIG. 10 shows a flowchart illustrating an example process performable by or at a network device that supports monitoring screen viewing and screen viewing impact across devices in a secure device ecosystem.

FIG. 11 shows a flowchart illustrating an example process performable by or at a network device that supports identifying a viewer among a plurality of viewers for monitoring screen viewing and screen viewing impact.

FIG. 12 shows a block diagram of an example wireless communication device that supports monitoring screen viewing and screen viewing impact across devices in a secure device ecosystem.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Electronic devices are an increasingly ubiquitous part of everyday life for most people. For example, many people across large and differing populations may use and interact with varying devices as part of their jobs, during studying, during leisure activities, for entertainment and many other uses. With the increase of device usage there are also increased risks to user or screen viewer well-being. For example, a viewer spending too much time viewing a screen of an electronic device during a given time period, such as over the course of a day or week, may cause negative physical and physiological impacts to the user. These negative impacts also may be increased in certain viewing environments that may increase viewer stress including environments with low light causing eye strain or high stress inducing environments where a viewer's continued use of the device may increase a stress reaction in the viewer. Some devices and device systems attempt to track a viewer's screen usage or screen viewing time; however, these methods often lack insight into a viewer's screen viewing beyond a specific device and also lack insight into the environmental and physiological impacts or effects of the screen time of the viewer.

Various aspects relate generally to monitoring screen viewing time and more particularly to monitoring screen viewing and screen viewing impact across devices in a secure device ecosystem. Some aspects more specifically relate to monitoring a viewer's screen time across various devices in the secure device ecosystem and providing a screen impact action representing an overall measure or impact of the screen viewing time to the viewer. For example, negative effects of screen viewing time may be increased due to adverse environmental and physical conditions of the viewer, where the overall measure or impact of the screen viewing time is adjusted to account for these negative effects. In some examples, a network device in the secure device ecosystem receives screen viewing data for viewers from devices with screens or display devices in the secure device ecosystem. Display devices may include many different types of devices that have user interface screens including mobile phones, laptops, tablets, extended reality (XR) devices, televisions and other similar devices. In some examples, the network device also receives sensor data associated with the viewers from sensor devices in the secure device ecosystem including wearable devices, internet-of-thing devices, cameras and other similar devices. The network device generates and outputs a screen impact action for a viewer using the screen viewing data and the sensor data. For example, the screen impact action may be generated using a screen impact factor and adjusted screen time for the viewer. In some examples, the screen impact factor represents additional negative impacts of screen viewing on the viewer caused by the environmental and physical conditions around the viewer during a screen viewing time. In some examples, the screen impact factor for the viewer can be generated from the sensor data to represent the environmental or other physical conditions impacting the viewer. The screen impact factor also may be used to generate the adjusted screen viewing time by adjusting a screen viewing time from the screen viewing data. In some examples, the adjusted screen viewing time represents the overall impact of the screen viewing time on the viewer. For example, when the environmental and physical conditions around the viewer increase the negative aspects of screen viewing time, the screen impact factor can be used to add more time to the screen viewing time to produce the adjusted screen viewing time, which represents an actual impact of the screen viewing time on the viewer.

In some aspects, the screen viewing time of the viewer may be adjusted based on environmental conditions and physiological conditions impacting the viewer while viewing the screen. For example, the screen impact factor used to adjust the screen viewing time for the viewer is generated using a viewer stress factor determined using biometric sensor data associated with the viewer. In some examples, the screen impact factor also can be generated using an ambient environment factor determined from environmental data associated with a physical environment where the viewer is viewing a display device.

In some aspects, to provide an overall or comprehensive screen impact action for the viewer across multiple display devices, the screen viewing time is a combined viewing time compiled from the multiple display devices in the secure device ecosystem. In some aspects, the network device also can provide an indication of whether a viewer is approaching a set limit for screen viewing time. For example, the screen impact action may include a displayable warning or cause a screen block for the viewer when the adjusted screen viewing time is above the screen viewing limit for the viewer.

In some aspects, the network device also may provide a screen impact action for multiple viewers. In some examples, the network device may identify a specific viewer from the multiple viewers in order to provide the screen impact factor for the specific viewer. Additionally, the network device also may identify each of the multiple viewers and provide individualized screen impact factors for each of the viewers. In some examples, the network device selects or filters the screen viewing data and the sensor data to only the data and screen viewing time associated with the viewer for use in generating the screen impact action. For example, the network device may use facial recognition to identify individuals, including the viewer, in the screen viewing data. The network device also may calculate a screen viewing time for the viewer based on whether a viewer is looking at or facing a screen using viewing factors. For example, the viewing factors may include view angles and distance of the viewer relative to a screen, where only the time the viewer is looking at or engaged with the screen is included in the screen viewing time. In some examples, the network device also may provide screen impact actions to the multiple viewers in the screen viewing data. For example, the network device may identify each viewer and provide respective screen impact actions for each of the respective viewers.

Particular aspects of the subject matter described in this disclosure can be implemented to realize one or more of the following potential advantages. Screen impact actions from the network device in the secure device ecosystem may provide a representation of a viewer's screen time that accounts for the viewer's watching condition as well as a measure of the viewer's screen time across multiple devices. For example, by compiling screen time data and sensor data from multiple devices in the secure device ecosystem, aspects of the present disclosure may measure and provide insight into a viewer's screen viewing time across the various devices with which the viewer interacts. In some aspects, screen viewing time and screen impact actions may be sourced from screen viewing data and sensor data that includes data associated with multiple viewers, where each viewer's screen time and related sensor data is selected from the screen viewing and sensor data. In some examples, the multiple viewer data may provide for individualized screen time monitoring and screen impact actions for multiple viewers of the display devices in the secure device ecosystem based on various identifying information, such as facial recognition, and individual impact factors.

Additionally, measuring and adjusting a screen viewing time based on the impact of the viewers environment and physical conditions may enable the screen impact action to provide more detailed information to the viewer or viewers beyond a simple measure of time that the viewer has spent in front of screens. For example, adjusting the screen time based on the viewing environment, including lighting conditions, and the viewers physical condition, such as elevated stress levels, may provide a more comprehensive representation of the physical and physiological impact of the screen viewing time on the viewer. In some aspects, the screen impact action also may include a warning or blocks the viewer's screen which can provide a technical interruption to the potentially negative continued screen usage by the viewer.

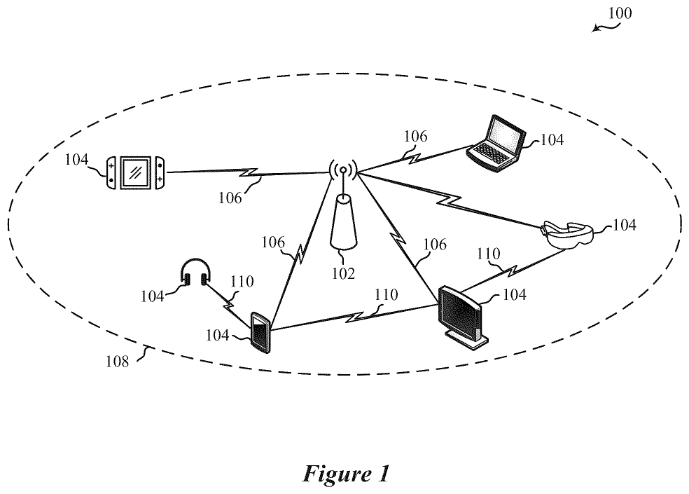

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

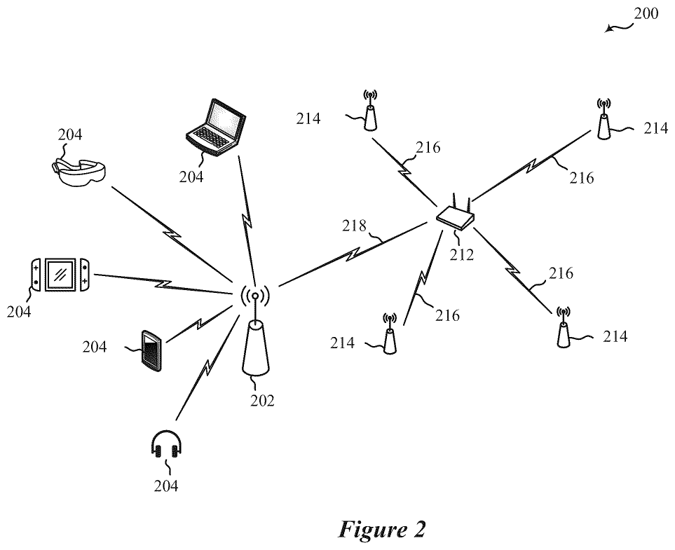

FIG. 2 shows a pictorial diagram of another example wireless communication network 200. According to some aspects, the wireless communication network 200 can be an example of a mesh network, an IoT network or a sensor network in accordance with one or more of the IEEE 802.11 family of wireless communication protocol standards (including the 802.11ah amendment). The wireless communication network 200 may include multiple wireless communication devices 214, which in some implementations may include APs 202, STAs 204, or both. The wireless communication devices 214 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links, or other PAN or short-range communication links.

In some examples, the intermediate device 212 also may be configured for wireless communication with other networks such as with a WLAN or a wireless (for example, cellular) wide area network (WWAN), which may, in turn, provide access to external networks including the Internet. For example, the intermediate device 212 may associate and communicate, over a Wi-Fi link 218, with an AP 202 of a wireless communication network 200, which also may serve various STAs 204. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

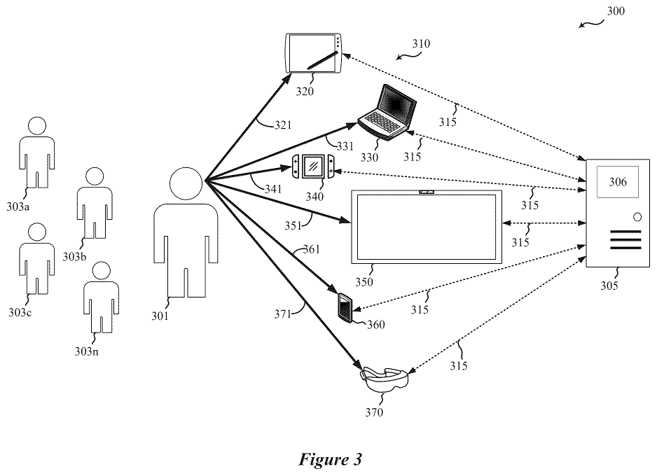

FIG. 3 shows a pictorial diagram of an example secure device ecosystem 300. In some implementations each of the devices in the secure device ecosystem 300 support monitoring screen viewing time and screen viewing impact across display devices in a secure device ecosystem. In some examples, various devices are communicatively connected a secure device server 305 in the secure device ecosystem 300 via a network such as the wireless communication network 100 and the wireless communication network 200 as described with reference to FIGS. 1 and 2. In some examples, the various devices in the secure device ecosystem 300 are wireless communication devices, such as STAs, APs or other network devices, which are authenticated to a secure multi-device identification service 306. For example, the secure multi-device identification service 306 may provide identification, registration and authentication to the wireless communication devices in the secure device ecosystem 300 as trusted devices via the secure device server 305 or via a distributed or cloud based secure multi-device authentication service. In some examples, the trusted devices may securely communicate with other trusted devices in the secure device ecosystem 300. For example, the trusted devices may communicate data for the secure device ecosystem 300, such as screen viewing data, sensor data associated with viewers, screen impact actions and other secure information between the trusted devices without requiring additional security processes between the devices.

In some implementations, the secure device ecosystem 300 includes display devices 310, where the display devices include screens or other user interfaces that may be viewed, watched or seen by a user or a viewer 301 and viewers 303a, 303b, 303c and 303n. For example, the display devices 310 include a tablet 320, a computer 330, a gaming device 340, a TV 350, a mobile phone 360 and an XR device 370. In some examples, the viewers 301 and 303a-303n may interact with the display devices 310, where interacting with the devices includes viewing any combination of the display devices 310 during a given time duration, such as a 24 hour/day period, week, etc. In some examples, the display devices 310 track or compile screen viewing data for the viewer 301 and viewers 303a-303n.

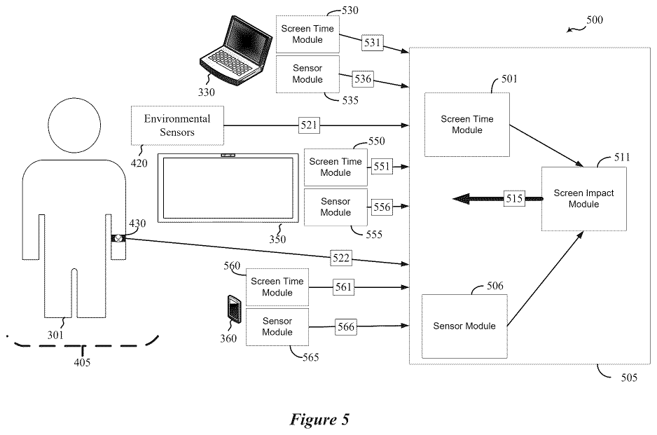

For example, for the viewer 301, the tablet 320 tracks view time 321, the computer 330 tracks view time 331, the gaming device 340 tracks view time 341, the TV 350 tracks view time 351, the mobile phone 360 tracks view time 361 and the XR device 370 tracks view time 371. In some examples, the tracked view time(s) includes tracked or collected screen viewing data including a screen viewing time, such as the duration of time the viewer 301 is viewing the device, as well as other viewing metrics, including eye movement, blink rate and other attention tracking/viewing metrics. In some examples, the screen viewing data from the various devices may be shared among all the network devices in the secure device ecosystem 300. For example, the display devices 310 and the secure device server 305 may share screen viewing data 315 from each display device to each other display device. In some examples, the display devices 310 also may provide screen viewing data directly to each other through direct communication links, instead of through the secure device server 305 or other intermediary network. Collecting and sharing screen viewing data among the devices in the secure device ecosystem 300 is described in more detail with reference to FIG. 5.

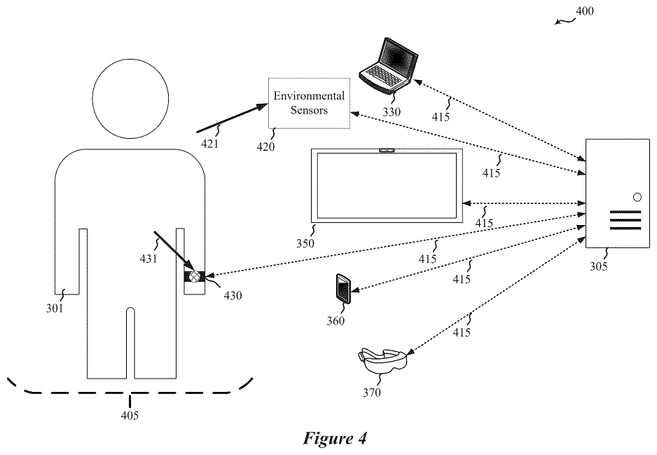

In some examples, the display devices 310 and the secure device server 305 may use the screen viewing data 315 shared from all the display devices 310 to determine a screen viewing time for the viewer and generate a screen impact factor for a viewer, such as the viewer 301. In some examples, a screen impact factor is generated using additional data, such as sensor data described in more detail herein with reference to FIGS. 4 and 5. In some examples, the screen time data and screen viewing time is compiled across all of the display devices 310 in the secure device ecosystem 300. In some examples, the secure device server 305 and the devices 310 compile screen time data from multiple devices in the secure device ecosystem 300, to provide a measure of impact of the viewer's screen viewing time across the various devices with which the viewer interacts.

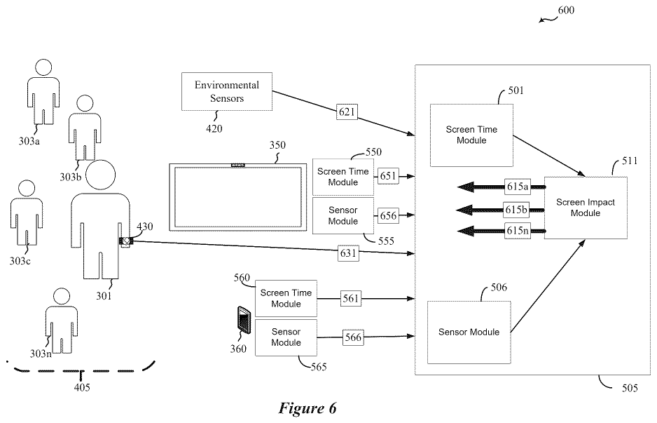

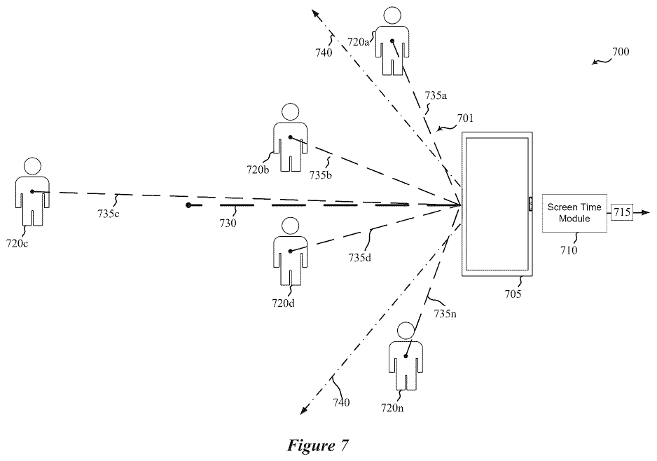

In some examples, screen viewing time may be sourced from screen viewing data that includes data associated with multiple viewers, where each viewer's screen time and related sensor data is selected from the screen viewing and sensor data. For example, the viewer 301 and the viewers 303a-303n also may view the TV 350 for a period of time, together or at separate times. In some examples, the secure device server 305 and the display devices 310 may identify each of the viewers from screen viewing data and provide individualized screen viewing time monitoring and individual screen impact actions for each of the viewers as described in more detail with reference to FIGS. 6 and 7.

As described above, the display devices 310 and the secure device server 305 may generate and output screen impact actions using the screen impact factors to alert the viewer 301 or others when an impact of viewing screens has crossed a threshold. In some examples, screen impact actions in the secure device ecosystem 300 provide a representation of the viewer 301's screen time that accounts for the viewer's watching condition as well as a measure of the viewer's screen time across multiple display devices 310. In some implementations, the screen impact action includes visual element such as a displayable warning or a block of the viewer's screen, which can provide a technical interruption to the potentially negative continued screen usage by the viewer, as described in more detail with reference to FIGS. 5-9. Additionally, measuring and adjusting a screen viewing time based on the impact of the viewers environment and physical conditions, represented by the sensor data, enables the screen impact action to provide more detailed information to the viewer or viewers beyond a simple measure of time that the viewer has spent in front of screens of the display devices. In some examples, adjustment of screen viewing time is done using a screen impact factor generated from sensor data as discussed in FIG. 4.

FIG. 4 shows a pictorial diagram of example sensor devices in a secure device ecosystem arrangement 400. In some examples, the secure device ecosystem arrangement 400 is a subset of the trusted devices of the secure device ecosystem 300 and includes sensor devices that provide sensor data associated with a viewer. In some examples, the sensors device may include devices authenticated to the secure multi-device identification service 306 described with reference to FIG. 3 and include environmental sensors 420 and sensors on a wearable device 430, which provide sensor data 415 in the secure device ecosystem 300. In some examples, the environmental sensors 420 and the wearable device 430 may securely communicate with other trusted devices in the secure device ecosystem 300, including the display devices 310 and the secure device server 305. For example, the environmental sensors 420 and wearable device 430 may provide the sensor data 415 without requiring additional security processes between the devices. In some implementations, display devices also may provide sensor data in the secure device ecosystem 300. For example, some or all of the display devices 310, including the computer 330, the TV 350, the mobile phone 360 and the XR device 370 also may provide sensor data 415. In some examples, other sensor devices and display devices, not shown in FIG. 4, also may provide sensor data 415.

In some examples, the sensor data 415 includes biometric data for the viewer 301 and data representing ambient conditions of a physical environment 405 around the viewer. For example, environmental sensors 420 may include various IoT devices or other sensor devices which collect environmental data 421 including temperature, ambient light conditions and other environmental data representing the physical environment 405 associated with the viewer 301 during a screen viewing session. In some examples, the wearable device 430 collects biometric information or biometric data 431 representing various biometric or physiological conditions of the viewer 301. For example, the biometric data 431 collected by the wearable device 430 may include heart rate, body temperature, oxygen saturation, viewer posture, time seated and other information representing a physical state of the viewer 301 while viewing a screen or display device.

In some examples, the screen impact factor is calculated using the various sensor data and information provided in the sensor data 415. In some examples, the screen impact factor is generated using an ambient environment factor which is calculated from the sensor data 415 and based on the environmental data 421 associated with the viewer 301, during a screen viewing session of any of the display devices 310. For example, the ambient environment factor may be calculated to represent ambient lighting, temperature or other environmental conditions that may impact a viewer using a display device. In some examples, the sensor data 415 is also used to generate a stress factor for the viewer 301 while viewing a screen or display device. For example, the stress factor may be calculated to represent the user's measure physiological reaction or state while using a display device.

In some examples, a measured screen viewing time associated with the viewer 301 is adjusted based on the impact of the viewer's environment and physical conditions. In this example, the adjusted screen viewing time or screen impact factor enables a screen impact action to provide more detailed information to the viewer or viewers beyond a simple measure of time that the viewer has spent in front of screens. In some examples, adjusting the screen time based on the viewing environment, including lighting conditions, and the viewers physical condition, such as elevated stress levels, provides a more comprehensive representation of the physical and physiological impact of the screen viewing time on the viewer. Example screen impact factors and screen viewing time adjustments are described in more detail with reference to FIGS. 5-8.

FIG. 5 shows a pictorial diagram of example secure device ecosystem arrangement 500 that supports monitoring screen viewing and screen viewing impact across devices for a viewer. In some examples, the arrangement 500 includes a network device 505 in the secure device ecosystem 300 described with reference to FIG. 3. In some examples, the network device 505 may operate as or within the secure device server 305, the display devices 310 or other network device in the secure device ecosystem 300. In some examples, the network device 505 receives screen viewing data, such as the screen viewing data 315 described with reference to FIG. 3, for the viewer 301 from devices with screens or display devices in the secure device ecosystem 300. In some examples, the network device 505 also receives sensor data, such as the sensor data 415 described with reference to FIG. 4, for the viewer 301 from sensor devices in the secure device ecosystem 300. The network device 505 uses the received screen viewing data and sensor data to generate a screen impact action 515 as described herein.

In some examples, the arrangement 500 includes display devices that the viewer 301 has viewed during a given time period. Time periods for tracking may include a day or 24 hour period, a workday or 8-10 hour period, or other defined period of time the viewer or other user would like to track screen viewing or device usage. In some examples, time periods for tracking may be set or determined based on identifying features of the viewer 301. For example, a time period for tracking may be selected or determined using screen time settings and may be associated with a gender, age, physical and physiological conditions of the viewer, identity of the viewer, or other similar factors. In some examples, the various factors for selecting or determining the time period for tracking may be obtained, ascertained or derived using facial recognition processes in association with an image of the viewer 301.

In some examples, during a 24 hour period, the viewer 301 may view or interact with the computer 330, the TV 350 and the mobile phone 360. The viewer 301 may desire to track the time screens/displays are viewed and also limit the time screen or display devices are viewed or used. In some examples, each of the display devices and the network device 505 include a screen time module which compiles and reports screen viewing data and sensor data to other devices in the secure device ecosystem 300. For example, a screen time module 530 provides screen viewing data 531 to a screen time module 501 of the network device 505. In some examples, a screen time module 550 also provides screen viewing data 551 and a screen time module 560 provides screen viewing data 561 to the screen time module 501.

In some implementations the screen viewing data, including screen viewing data 531, 551 and 561 may include locally measured screen viewing time for the viewer 301. For example, the screen viewing data 531 may include a screen viewing time for the viewer 301 measured by the computer 330. In some examples, the computer 330 may associate the viewer 301 with the screen viewing time using a user login. For example, the viewer 301 may log into the computer 330 using a unique user identification for the viewer 301. In some examples, the computer 330 and screen time module 530 also may use facial recognition or other visual recognition via a camera or other visual sensor on the computer 330 to associate the viewer with device usage or screen viewing.

As the viewer 301 interacts with the computer 330 or views a display or screen of the computer 330, the screen time module 530 tracks the amount of time and reports the time in the screen viewing data 531 as the screen viewing time. In some examples, the screen viewing data 531 may include raw or unprocessed data, such a general screen viewing time for the computer 330 without associating the screen viewing time with the viewer 301. In some examples, the screen time module 501 may process the screen viewing data 531 to determine and associate the screen viewing time with the viewer 301. In some examples, the screen viewing data may include screen viewing data associated with multiple different viewers as described in greater detail with reference to FIGS. 6 and 7.

In some examples, the network device 505 also receives sensor data associated with the viewer 301 from sensor devices in the secure device ecosystem including wearable devices, IoT devices, cameras and other similar devices, including sensors associated with the display devices. In some examples, the sensor devices and the display devices may report sensor data to a sensor module 506 on the network device 505. For example, the environmental sensors 420 provide sensor data 521 and the wearable device 430 provides sensor data 522 to a sensor module 506 in the network device 505. The display devices also may report sensor data collected from sensors on the display devices via a sensor module. For example, a sensor module 535 provides sensor data 536, sensor module 555 provides sensor data 556, and sensor module 565 provides sensor data 566, each providing respective sensor data to the sensor module 506 on the network device 505.

In some implementations the sensor data, including sensor data 521, 522, 536 and 566 may include a locally generated screen impact factor for the viewer, generated at a local sensor device for the viewer 301. For example, the sensor data 521 may include a screen impact factor or environment impact factor for the viewer 301 generated at the environmental sensors 420. Additionally, the mobile phone 360 and the sensor module 565 also may collect sensor data at the mobile phone 360 and generate a screen impact factor for the viewer 301 associated with the screen viewing time of the mobile phone 360 or associated with a screen viewing time of another device, such as the TV 350. In some examples, the sensor devices may associate the viewer 301 with sensor data using user login, facial recognition or other identifying information.

For example, the viewer 301 may log into the mobile phone 360, wearable device 430 or other sensor device using a unique user identification for the viewer 301. In some examples, the sensor devices also may use facial recognition or other visual recognition via a camera or other visual sensor on the sensors device to associate the viewer with device usage or screen viewing. For example, as the viewer 301 is present in the physical environment 405, the environmental sensors 420 tracks the ambient light and other environmental data of the physical environment 405. In some examples, the sensors, such as the wearable device 430 also may track biometric information, such as heart rate or other physiological state data of the viewer 301.

In some examples, the sensor devices generate a screen impact factor for a given time period and report the screen impact factor in the sensor data. In some examples, the sensor module 506 may associate the locally generated screen impact factor with the viewer 301 and a given viewing time period or screen viewing time. In some examples, the screen viewing data 531 also may include raw or unprocessed data, such as a general sensor data with time stamped information, without associating the sensor data to the viewer 301 or generating a screen impact factor. In some examples, the sensor module 506 may process the sensor data to associate the sensor data with the viewer 301 and a screen viewing time received in the screen viewing data to generate a screen impact factor. In some examples, the sensor data may include sensor data associated with multiple different viewers as described in greater detail with reference to FIG. 6.

In some examples, the network device 505 uses the reported screen viewing data and sensor data associated with the viewer 301 to generate a screen impact factor and provide the screen impact action 515 to the viewer or other user. For example, a screen impact module 511 may receive the screen viewing data and sensor data reported from the sensor and display devices from the screen time module 501 and sensor module 506. The screen impact module 511 generates and outputs the screen impact action 515 for the viewer 301, using the screen viewing data and the sensor data.

In some examples, the screen impact module 511 compiles or combines the screen viewing time from all of the display devices, such as the computer 330, the TV 350 and the mobile phone 360 to generate a comprehensive or combined screen viewing time. In some examples, the screen viewing time is adjusted by the impact factor to provide a comprehensive screen impact action for the viewer across the multiple display devices. For example, the screen impact module 511 may use a screen impact factor and an adjusted screen time for the viewer to generate the screen impact action 515. In some examples, the screen impact factor represents additional negative impacts of screen viewing on the viewer caused by the environmental and physical conditions of the physical environment 405 around the viewer 301 during a screen viewing time.

In some examples, the screen impact module 511 generates the screen impact factor for the viewer from the sensor data to represent the environmental or other physical conditions impacting the viewer. For example, the adjusted screen viewing time may represent the overall impact of the screen viewing time on the viewer. For example, when the environmental and physical conditions around the viewer increase the negative aspects of screen viewing time, the screen impact module 511 uses the screen impact factor to add more time to the screen viewing time to produce the adjusted screen viewing time, which represents an actual time impact of the screen viewing time on the viewer.

For example, the viewer 301 may view a screen of the TV 350 for 50 minutes, the mobile phone 360 for 45 minutes and the computer 330 for 90 minutes. In some examples, the compiled screen viewing time for the viewer 301 across the devices is 185 minutes. In some examples, the screen impact module 511 generates the screen impact factor based on environmental conditions and physiological conditions impacting the viewer while viewing the screen to represent an overall impact of viewing the screen on the user. For example, the screen impact module 511 may use biometric sensor data associated with the viewer to generate a viewer stress factor. In some examples, the screen impact module 511 also may use an ambient environment factor determined from environmental data associated with a physical environment where the viewer is viewing a display device to generate the screen impact. For example, while viewing the mobile phone 360 the biometric sensor data in the screen viewing data 531 may indicate the viewer 301 is experiencing higher blood pressure, lower blood oxygen saturation or other negative biometric impacts.

In some examples, the environmental data in the sensor data 521 may indicate that the lighting, ambient temperature or other environmental factors are likely to increase negative effects on the viewer during the viewing time of the TV 350, mobile phone 360 and computer 330. In some examples, the screen impact module 511 may combine the stress factor and the ambient environment factor to produce the overall impact factor used to adjust the screen viewing time and to generate the screen impact action 515. For example, the impact factor for the viewer 301 across the display devices for a given time period may increase the combined screen viewing time from 185 minutes to an adjusted screen viewing time of 215 minutes. In some examples, each time screen viewing time may be adjusted according to the impact factor for the same time period, environment and viewing device. For example, a screen impact factor may be calculated for the screen viewing time associated with the mobile phone 360 and a different screen impact factor may be calculated for the screen viewing time associated with the TV 350.

In some examples, the screen impact action 515 includes various information that may be displayed on a user interface or otherwise provided to the viewer 301 or other person/user, such as a parent or caretaker. For example, the screen impact action 515 may include a displayed indication of whether the viewer 301 is approaching screen viewing limit for the viewer. For example, the viewer 301 may have a screen viewing limit of 230 minutes, set by the viewer or other person/user. In some examples, the screen impact action includes a displayable notification indicating a comparison between a screen viewing limit for the viewer and the adjusted screen viewing time. For example, the screen impact action 515 may include a notification that the viewer is at 215 minutes of screen viewing time or within 15 minutes of the screen viewing limit of 230 minutes. In this example, even though the user has only viewed the screens/displays for 185 minutes, the overall impact of the screen viewing of the viewer is represented by the adjusted screen viewing time.

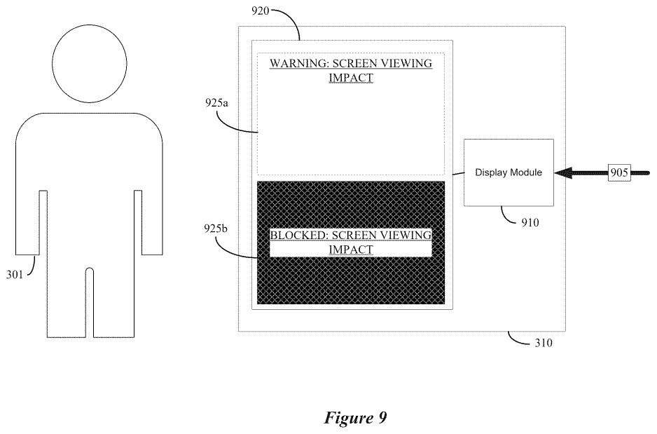

In some examples, as the adjusted screen viewing time meets the screen viewing limit, the screen impact action may include a displayable warning or cause a screen block for the viewer. For example, upon reaching 230 minutes in the adjusted screen viewing time, the screen impact action 515 may include a warning that may be displayed on the screens of the display devices that indicates the screen viewing limit has been reached. In some examples, the screen impact action 515 also may cause the displays of the display devices to be blocked from further interactions or viewing by the viewer 301. Additional screen impact actions are discussed with reference to FIG. 9. In some examples, the network device also may provide a screen impact action for multiple viewers in the secure device ecosystem 300 including multiple viewers of single display device. In some examples, the network device may identify respective viewers from the multiple viewers in order to provide individual screen impact factors for the viewer as described in more detail with reference to FIG. 6.

FIG. 6 shows a pictorial diagram of example secure device ecosystem arrangement 600 that supports monitoring screen viewing and screen viewing impact across devices for multiple viewers. In some examples, the arrangement 600 includes the network device 505 in the secure device ecosystem 300 described with reference to FIG. 3. In some examples, the network device 505 may operate as or within the secure device server 305, the display devices 310 or other network device in the secure device ecosystem 300. In some examples, the network device 505 receives screen viewing data, such as the screen viewing data 315 described with reference to FIG. 3, for the viewer 301 and the viewers 303a-303n from devices with screens or display devices in the secure device ecosystem 300. In some examples, the network device 505 also receives sensor data, such as the sensor data 415 described with reference to FIG. 4, for the viewer 301 and the viewers 303a-303n from sensor devices in the secure device ecosystem 300. The network device 505 uses the received screen viewing data and sensor data to generate one or more screen impact actions for the viewers such as screen impact actions 615a, 615b and 615n.

In some examples, the arrangement 600 includes display devices that the viewers 301 and 303a-303n have viewed during a given time period. Time periods for tracking may be individualized for each respective viewer and may include a day or 24 hour period, a workday or 8-10 hour period, or other defined period of time the respective viewer or other user would like to track screen viewing or device usage. In some examples, during a 24 hour period, the viewers 301 and 303a-303n may view or interact with any of the display devices described with reference to FIG. 3, and individual display devices, such as individual mobile phones, tablets and other display devices. In some examples, the viewers 301 and 303a-303n also may all view a shared displayed devices such as the TV 350. In some examples, some or all of the viewers 301 and 303a-303n may desire to track the time screens/displays are viewed and also limit the time screen or display devices are viewed or used. In some examples, each of the display devices and the network device 505 include a screen time module which compiles and reports screen viewing data for multiple viewers and sensor data associated with multiple users to other devices in the secure device ecosystem 300. For example, the screen time module 550 provides screen viewing data 651, including viewing data associated with multiple viewers, to the screen time module 501 of the network device 505. In some examples, the screen time module 560 provides screen viewing data 561, associated with only one viewer such as the viewer 301, to the screen time module 501.

In some implementations the screen viewing data, including screen viewing data 651, may include locally measured screen viewing time for the viewers 301 and 303a-303n. In some examples, the TV 350 may associate the viewers with the respective screen viewing times using a user login or digital other identifying metric. In some examples, the computer 330 and screen time module 530 also may use facial recognition or other visual recognition via a camera or other visual sensor on the computer 330 to associate the viewer with device usage or screen viewing as well as measure a time the viewers are viewing the screen as described in more detail with reference to FIG. 7.

As the viewers 301 and 303a-303n interact with the TV 350 or views a display or screen of the TV 350, the screen time module 550 tracks the amount of time for each respective viewer and reports the time in the screen viewing data 651. In some examples, the screen viewing data 651 may include raw or unprocessed data, such as a general screen viewing time for the TV 350 along with data that associates the screen viewing time with the viewers 301 and 303a-303n. In this example, the screen time module 501, at the network device 505, may process the screen viewing data 651 to determine and associate a screen viewing time with the respective viewers 301 and 303a-303n.

In some examples, the network device 505 also receives sensor data associated with the viewers 301 and 303a-303n from sensor devices in the secure device ecosystem including wearable devices associated respective viewers and other similar devices, including sensors associated with the display devices. In some examples, the sensor devices and the display devices may report sensor data to a sensor module 506 on the network device 505. For example, the environmental sensors 420 provide sensor data 621 associated with multiple viewers and the wearable device 430 as well as wearable devices from other viewers provides sensor data 631 to the sensor module 506 in the network device 505. The display devices also may report sensor data collected from sensors on the display devices via a sensor module. For example, the sensor module 555 provides sensor data 656 associated with the multiple viewers to the sensor module 506 on the network device 505.

In some implementations the sensor data may include a locally generated screen impact factor for the viewer, generated at a local sensor device for the viewers 301 and 303a-303n. For example, the sensor data 621 may include a screen impact factor or environment impact factor for the respective viewers 301 and 303a-303n generated at the environmental sensors 420. Additionally, the TV 350 and the sensor module 555 also may collect sensor data at the TV 350 and generate a screen impact factor for the viewers 301 and 303a-303n associated with the screen viewing time of the TV 350.

In some examples, the network device 505 uses the reported screen viewing data and sensor data associated with the viewers 301 and 303a-303n to generate a screen impact factor for each viewer and provide the screen impact actions 615a-615n to the respective viewers or other users. For example, the screen impact module 511 may receive the screen viewing data and sensor data reported from the sensor and display devices from the screen time module 501 and sensor module 506. The screen impact module 511 generates and outputs the screen impact actions 615a-615n for the viewers 301 and 303a-303n, using the screen viewing data associated with each respective user and the respective sensor data as described in more detail with reference to FIG. 5.

FIG. 7 shows a pictorial diagram of example secure device ecosystem arrangement 700 that supports identify multiple viewers of a device and monitoring screen viewing for the multiple viewers. In some examples, the arrangement 700 includes a network device 705 in the secure device ecosystem 300 described with reference to FIG. 3. In some examples, the network device 705 may operate as or within the secure device server 305, the display devices 310 or other network device in the secure device ecosystem 300. For example, the network device 705 may operate as or within the TV 350 described with reference to FIG. 3. In some examples, the network device 705 also may operate as or within the network device 505 described with references to FIGS. 5 and 6. In some examples, the network device 705 tracks or receives screen viewing data 701 which includes viewing metric associated with each viewer.

For example, viewers 720a-720n may each view a display associated with the network device 705. In some examples, the device may include an associated view distance threshold 730 and a view angle threshold 740. In some examples, a viewer outside of the view distance threshold 730 or the view angle threshold 740 may be considered as not viewing the device. In some examples, the network device 705 may identify each of the viewers 720a-720n in the screen viewing data 701 using facial recognition process or other identifying processes described with reference to FIG. 5.

In some examples, the network device 705 also determines or associates a threshold view distance for each respective viewer from the screen viewing data 701. For example, the viewer 720a is at a view distance 735a, the viewer 720b is at a view distance 735b, the viewer 720c is at a view distance 735c, the viewer 720d is at a view distance 735d and the viewer 720n is at a view distance 735n. In some examples, the distance 735c is greater than the distance threshold 730 indicating that while the viewer 720c is at that distance the network device 705 may not include that time as screen viewing time.

In some examples, the network device 705 also determines or associates a threshold view angle for each respective viewer from the screen viewing data 701. For example, the viewers 720a and 720n are both at view angles outside of the view angle threshold 740. In some examples, when the viewers 720a and 720n are both at view angles outside of the view angle threshold 740 the network device 705 may not include that time as screen viewing time.

In some examples, the network device 705 also tracks a minimum screen time of the respective viewer. For example, the viewer 720b may view the network device 705 for a short period of time, such as less than 60 seconds, before looking away, moving past the distance threshold 730 or view angle threshold 740. In some examples, when the minimum time the viewer is associated with viewing the device is below the minimum screen time threshold the network device 705 may not include the time in the screen time viewing data. In some examples, the screen time module 710 provides screen time data to other devices in the secure device ecosystem 300, such as the network device 505, such that the network device 505 uses the received screen viewing data 715 and sensor data to generate one or more screen impact actions for a single viewer or multiple viewers such as screen impact actions 515 and-5a- 615n described with reference to FIGS. 5 and 6.

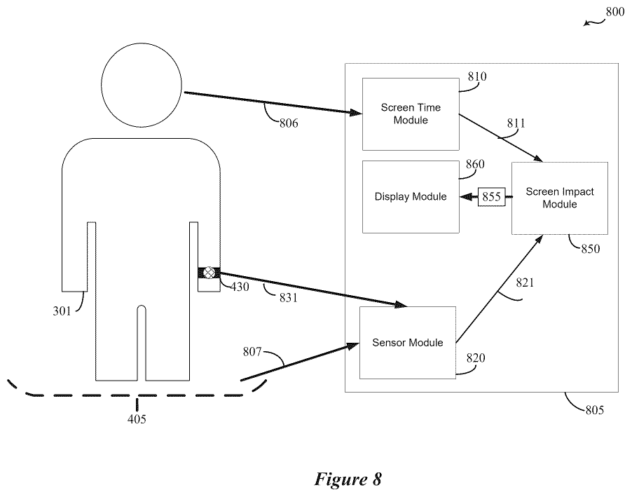

FIG. 8 shows a pictorial diagram of example secure device ecosystem arrangement 800 that supports monitoring screen viewing and screen viewing impact at a local device for a viewer. In some examples, the arrangement 800 includes a network device 805 in the secure device ecosystem 300 described with reference to FIG. 3. In some examples, the device 805 may operate as or within one of the display devices 310 or other network device in the secure device ecosystem 300. In some examples, the local network device 805 may not have a current communication link with the remaining devices in the secure device ecosystem 300. For example, the device 805 may be offline or out of range of a network. In some examples, the device 805 tracks local screen viewing data 811 associated with screen viewing time 806 for the viewer 301 at the screen time module 810. In some examples, the local network device 805 also tracks or receives local sensor data, such as the sensor data 415 described with reference to FIG. 4, for the viewer 301 from local sensor devices, such as the wearable device 430 or via a sensor module 820. In some examples, the local network device 805 local network device 805 uses the tracked or received screen viewing data and sensor data to generate a local screen impact action 855.

In some examples, during a given period, the viewer 301 may view or interact with a display of the local network device 805. The viewer 301 may desire to track the time screens or displays are viewed and also limit the time screen or display devices are viewed or used, even in an example where the device 805 is not able to communicate with other display devices in the secure device ecosystem 300. In some examples, the device 805 includes a screen time module 810 and sensor module 820, which compile and report screen viewing data and sensor data to a screen impact module 850. In some examples, the screen time module 810 and the sensor module 820 also may provide the screen time viewing data and sensor data to other devices in the secure device ecosystem 300 when the device 805 is able to reestablish communication with the network and ecosystem 300.

For example, the screen time module 810 provides local screen viewing data 811 to the module 850. In some examples, as the viewer 301 interacts with the local network device 805 or views a display or screen of the network device 805, the screen time module 810 tracks the amount of time and reports the time in the local screen viewing data 811. In some examples, the screen viewing data 811 may include raw or unprocessed data, such as a general screen viewing time for the local network device 805 without associating the screen viewing time with the viewer 301. In some examples, the module 850 may process the screen viewing data 811 to determine and associate the screen viewing time with the viewer 301. In some examples, the local screen viewing data may include screen viewing data associated with multiple different viewers as described in greater detail with reference to FIGS. 6-7. In some examples, the local network device 805 also receives sensor data associated with the viewer 301 from sensors on the local network device 805 or sensor devices with a direct connection to the device, such as the wearable device 430.

In some examples, the sensor module 820 devices may associate the viewer 301 with sensor data using user login, facial recognition or other identifying information. For example, the viewer 301 may log into the local network device 805 using a unique user identification for the viewer 301. In some examples, the sensor devices also may use facial recognition or other visual recognition via a camera or other visual sensor on the sensors device to associate the viewer with device usage or screen viewing. For example, as the viewer 301 is present in the physical environment 405, sensors on the local network device 805 may track the ambient light and other environmental conditions 807 of the physical environment 405. In some examples, the sensors, including sensors on the local network device 805 and sensors on devices with direct connections to the local network device 805, such as the wearable device 430 also may track biometric information 831, such as heart rate or other physiological state data of the viewer 301.

In some examples, the sensor data 821 also may include raw or unprocessed data, such as a general sensor data with time stamped information, without associating the sensor data to the viewer 301 or generating a screen impact factor. In some examples, the module 850 may process the sensor data to associate sensor data with the viewer 301 and a screen viewing time received in the screen viewing data to generate a local screen impact factor. In some examples, the sensor data also may include sensor data associated with multiple different viewers as described in greater detail with reference to FIG. 6.

In some examples, the device 805 uses the reported screen viewing data and sensor data associated with the viewer 301 to generate a local screen impact factor and provide the local screen impact action 855 to the viewer 301. The module 850 generates and outputs the local screen impact action 855 for the viewer 301, using the screen viewing data and the sensor data.

In some examples, the screen viewing time is adjusted by the impact factor to provide a comprehensive screen impact action for the viewer across for the local network device 805. For example, the module 850 may use a screen impact factor and an adjusted screen time for the viewer to generate the local screen impact action 855. In some examples, the screen impact factor represents additional negative impacts of screen viewing on the viewer caused by the environmental and physical conditions of the physical environment 405 around the viewer 301 during a screen viewing time at the local network device 805.

In some examples, the module 850 generates the screen impact factor for the viewer from the sensor data to represent the environmental or other physical conditions impacting the viewer. For example, the adjusted screen viewing time may represent the overall impact of the screen viewing time on the viewer. For example, when the environmental and physical conditions around the viewer increase the negative aspects of screen viewing time, the screen impact module 850 uses the screen impact factor to add more time to the screen viewing time to produce the local adjusted screen viewing time, which represents an actual time impact of the screen viewing time on the viewer.

In some examples, the environmental data in the sensor data 821 may indicate that the lighting, ambient temperature or other environmental factors are likely to increase negative effects on the viewer while viewing the network device 805. In some examples, the screen impact module 850 may combine the stress factor and the ambient environment factor to produce the overall impact factor used to adjust the screen viewing time and to generate the local screen impact action 855.

In some examples, the local screen impact action 855 includes various information that may be displayed on a user interface or otherwise provided to the viewer 301 or other person/user, such as a parent or caretaker. For example, the local screen impact action 855 may include a displayed indication of whether the viewer 301 is approaching screen viewing limit for the viewer that may be displayed via a display module 860.

In some examples, as the local adjusted screen viewing time meets the screen viewing limit, the screen impact action may include a displayable warning or cause a screen block for the viewer. For example, upon reaching a screen view limit, the local screen impact action 855 may include a warning that may be displayed by the module 860 that indicates the screen viewing limit has been reached. In some examples, the screen impact action 855 also may cause the module 860 to block display other content on a user interface or screen of the device 805. Additional screen impact actions are discussed with reference to FIG. 9.

FIG. 9 shows a pictorial diagram of an example display device 310 in a secure device ecosystem. In some examples, the display device 310 includes a display module 910 that receives a screen impact action 905. In some examples, the screen impact action may include any of the screen impact actions 515, 615a-615n and 855. In some examples, the screen impact action 905 includes information that may be displayed to the viewer 301 via a user interface or screen 920. In some examples, the screen impact action 905 and the display module 910 also may provide or otherwise display the screen impact action 905 to a person other than the viewer 301, such as a parent, guarding, supervisor or other administrator for screen viewing time. In some examples, the screen impact action 905 may include a notification indicating a comparison between a screen viewing limit for the viewer and the adjusted screen viewing time determined at a screen impact module, such as the screen impact modules described with reference to FIGS. 5, 6 and 8.

In some examples, the display module 910 may display the information or notification as warning or push notification such as a warning 925a. In some examples, the warning 925a may include displayed selectable interface elements that may be selected by the user 301 to implement device actions, including dismissing the warning, blocking a screen/display and adding time to a screen time limit, among other device actions. In some examples, the warning 925a may include screen viewing impact information such as a visual or textual indication that the adjusted screen viewing time is approaching the screen viewing limit, such as 10 minutes remaining, or is at or above the screen viewing limit. In some examples, the display module 910 also may block the display from further use such as screen block 925b. For example, the block 925b may prevent the viewer 301 from viewing content on the screen 920 and also may include screen viewing impact information such as a visual or textual indication that the adjusted screen viewing time is above the screen viewing limit. In some examples, the block 925b may include a displayed selectable interface element that may be selected by the user 301 to implement the screen block or decline to implement the screen block, among other device actions.

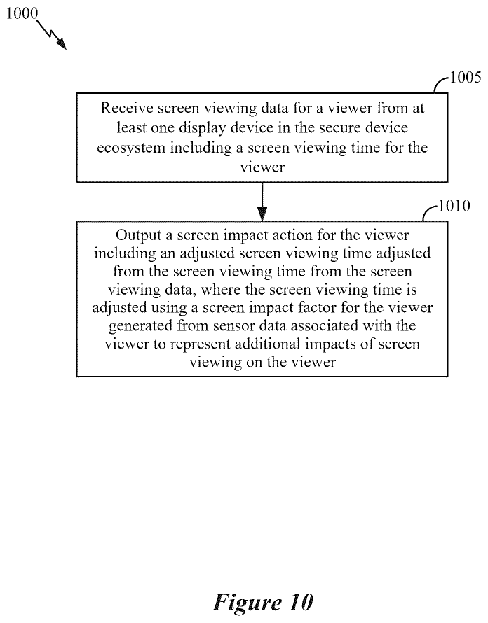

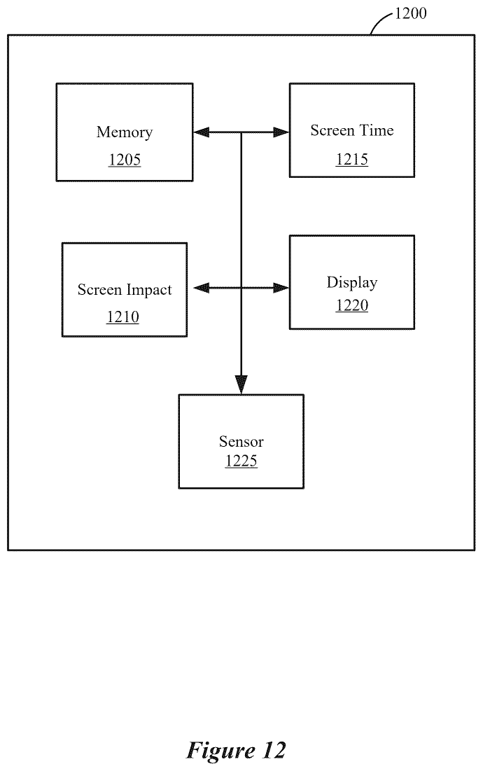

FIG. 10 shows a flowchart illustrating an example process 1000 performable by or at a network device that supports monitoring screen viewing and screen viewing impact across devices in a secure device ecosystem. The operations of the process 1000 may be implemented by a network device or its components as described herein. For example, the process 1000 may be performed by a wireless communication device, such as the wireless communication device 1200 described with reference to FIG. 12, operating as or within a STA, wireless AP or other network device. In some examples, the process 1000 may be performed by a wireless AP such as one of the APs 102 and 202, a wireless STA such as the STAs 104 and 204 described with reference to FIGS. 1 and 2 or a network device 505 described with reference to FIGS. 5 and 6.

In some examples, at block 1005, the network device receives screen viewing data for a viewer from at least one display device in the secure device ecosystem. In some examples, the screen viewing data includes a screen viewing time for the viewer. For example, network device may receive screen viewing data from display devices 310 which may include screen viewing data for only the viewer 301 or for multiple viewers such as viewers 301 and 303a-303n as described with reference to FIGS. 5 and 6. In some examples, the network device also may be a local network device that receives or tracks screen viewing data locally for the viewer 301 or for multiple viewers such as viewers 301 and 303a-303n as described with reference to FIG. 8.

In some examples, at block 1010, the network device outputs a screen impact action for the viewer. In some examples, the screen impact action includes an adjusted screen viewing time adjusted from a screen viewing time from the screen viewing data. In some examples, the screen viewing time is adjusted using a screen impact factor for the viewer generated from sensor data associated with the viewer to represent additional impacts of screen viewing on the viewer. For example, the network device may generate a screen impact action, such as the screen impact actions 515, 615a-615n and 855 as discussed with reference to FIGS. 5, 6 and 8.

In some examples, the network device provides the screen impact action to a viewer such as the viewer 301 or other user, such as a caretaker or monitor, to aid in tracking screen time viewing and device usage. The screen impact action may include displayable information such as warnings and screen blocks as discussed with reference to FIG. 9. In some examples, the screen impact actions from the network device in the secure device ecosystem provide a representation of a viewer's screen time that accounts for the viewer's watching condition as well as a measure of the viewer's screen time across multiple devices. The added insight provided by the screen impact actions allows for a viewer to more accurately track the potential negative effects of screen and device usage.

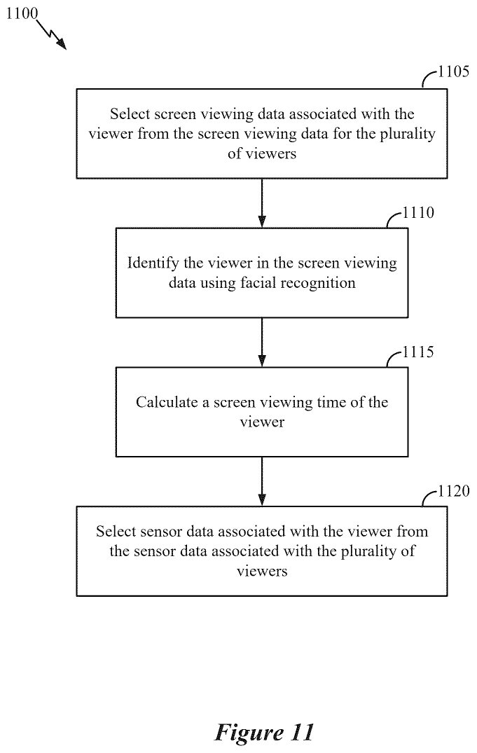

FIG. 11 shows a flowchart illustrating an example process 1100 performable by or at a network device that supports identifying a viewer among a plurality of viewers for monitoring screen viewing and screen viewing impact. The operations of the process 1100 may be implemented by a network device or its components as described herein. For example, the process 1100 may be performed by a wireless communication device, such as the wireless communication device 1200 described with reference to FIG. 12, operating as or within a STA, wireless AP or other network device. In some examples, the process 1100 may be performed by a wireless AP such as one of the APs 102 and 202, a wireless STA such as the STAs 104 and 204 described with reference to FIGS. 1 and 2 or a network device 505 described with reference to FIGS. 5 and 6.

In some examples, at block 1105, the network device selects screen viewing data associated with the viewer from the screen viewing data for the plurality of viewers. In some examples, the network device may select screen viewing data associated with the viewer using identifying information, such as a user login or other identifying information such as described with reference to FIGS. 5 and 6. In some examples, the network device may not be able to identify and select specific data for the viewer based on metadata or login information and the process 1100 proceeds to block 1110.

In some examples, at block 1110, the network device identifies the viewer in the screen viewing data using facial recognition. For example, the network device may identify the viewer 301 from the multiple users viewing or watching the TV 350 using facial recognition as applied to camera or other visual data received from or collected at the TV 350 as described with reference to FIGS. 6 and 7.

In some examples, at block 1115, the network device calculates a screen viewing time of the viewer using one or more screen viewing factors. For example, the screen viewing factors may include a threshold view angle of the viewer, a threshold view distance of the viewer and a minimum screen time of the viewer. For example, as described with reference to FIG. 7, for each identified viewer, the network device may determine or calculate the time each respective viewer watches the screen based on the distance from the display, angle of viewing the display and an at least minimum amount of time viewing the screen or display.

In some examples, at block 1120, the network device selects sensor data associated with the viewer from the sensor data associated with the plurality of viewers. For example, the network device may select sensor data received from various sensor device associated with one or more of the viewers to aid in generating a screen impact action for one or more of the viewers as described with reference to FIG. 6. In some examples, the network device uses the selected sensor data for the viewer to generate the screen impact factor for the viewer and output the screen impact action, as described with reference to block 1010 of FIG. 10.

FIG. 12 shows a block diagram of an example wireless communication device 1200 that supports monitoring screen viewing and screen viewing impact across devices in a secure device ecosystem. In some examples, the wireless communication device 1200 is configured to perform the processes 1000 and 1100 described with reference to FIGS. 10 and 11. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1200 may transmit the information output from the chip. In such an example, the second interface may refer to an interface between the processing system of the chip and a reception component, such that the device 1200 may receive information that is passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in an AP or STA, such as the AP 102 and the STA 104 described with reference to FIG. 1 and any of display devices, sensor devices or other network devices described with reference to FIGS. 3 and 4. In some other examples, the wireless communication device 1200 can be an AP, STA or other network device that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes a memory component 1205, a screen impact component 1210, a screen impact component 1210, a screen time component 1215, a display component 1220 and a sensor component 1225. Portions of one or more of the components 1205, 1210, 1215, 1220 and 1225 may be implemented at least in part in hardware or firmware. For example, the screen impact component 1210 may be implemented at least in part by a processor or a modem. In some examples, portions of one or more of the components 1205, 1210, 1215, 1220 and 1225 may be implemented at least in part by a processor and software in the form of processor-executable code stored in a memory.

Implementation examples are described in the following numbered clauses:

Clause 1. A network device in a secure device ecosystem, including: a processing system that includes one or more processors and one or more memories coupled with the one or more processors, the processing system configured to cause the network device to: receive screen viewing data for a viewer from at least one display device in the secure device ecosystem including a screen viewing time for the viewer; and output a screen impact action for the viewer including an adjusted screen viewing time adjusted from the screen viewing time from the screen viewing data, where the screen viewing time is adjusted using a screen impact factor for the viewer generated from sensor data associated with the viewer to represent additional impacts of screen viewing on the viewer.

Clause 2. The network device of clause 1, where the screen viewing time includes a compiled viewing time associated with the viewer across a plurality of display devices in the secure device ecosystem.

Clause 3. The network device of any of clauses 1 and 2, where the screen impact action includes a notification indicating a comparison between a screen viewing limit for the viewer and the adjusted screen viewing time.

Clause 4. The network device of any of clauses 1, 2 and 3, where the screen impact action includes a notification including a screen viewing warning when the adjusted screen viewing time is above the screen viewing limit.

Clause 5. The network device of any of clauses 1, 2, 3 and 4, where the screen impact action causes a blocked screen to be displayed on a display device of the at least one display device when the adjusted screen viewing time is above the screen viewing limit.

Clause 6. The network device of any of clauses 1, 2, 3, 4 and 5, where the screen impact factor is generated using a viewer stress factor calculated from the sensor data associated with the viewer, where the sensor data includes biometric data for the viewer.

Clause 7. The network device of any of clauses 1, 2, 3, 4, 5 and 6, where the screen impact factor is generated using an ambient environment factor calculated from the sensor data associated with the viewer, where the sensor data includes environmental data of a physical environment associated with the viewer during a screen viewing session.

Clause 8. The network device of any of clauses 1, 2, 3, 4, 5, 6 and 7, where the screen viewing data includes a locally measured screen viewing time for the viewer, measured at a local display device of the at least one display device.

Clause 9. The network device of any of clauses 1, 2, 3, 4, 5, 6, 7 and 8, where the sensor data includes a locally generated screen impact factor for the viewer, generated at a local sensor device of the at least one sensor device.

Clause 10. The network device of any of clauses 1, 2, 3, 4, 5, 6, 7, 8 and 9, where the screen viewing data includes screen viewing data for a plurality of viewers, where the sensor data includes sensor data associated with the plurality of viewers, and where the processing system is further configured to cause the network device to: select screen viewing data associated with the viewer from the screen viewing data for the plurality of viewers; and select sensor data associated with the viewer from the sensor data associated with the plurality of viewers.

Clause 11. The network device of any of clauses 1, 2, 3, 4, 5, 6, 7, 8, 9 and 10, where selecting screen viewing data associated with the viewer from the screen viewing data for the plurality of viewers further includes: identifying the viewer in the screen viewing data using facial recognition; and calculating a screen viewing time of the viewer using one or more of: a threshold view angle of the viewer, a threshold view distance of the viewer, and a minimum screen time of the viewer.

Clause 12. The network device of any of clauses 1, 2, 3, 4, 5, 6, 7, 8, 9, 10 and 11, where the processing system is further configured to cause the network device to: identify each other viewer of the plurality of viewers in the screen viewing data using facial recognition; and output a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a screen viewing time for the other viewer from the screen viewing data adjusted by the screen impact factor.

Clause 13. A method for screen impact monitoring, the method including: receiving screen viewing data for a viewer from at least one display device in a secure device ecosystem including a screen viewing time for the viewer; and outputting a screen impact action for the viewer including an adjusted screen viewing time adjusted from the screen viewing time from the screen viewing data, where the screen viewing time is adjusted using a screen impact factor for the viewer generated from sensor data associated with the viewer to represent additional impacts of screen viewing on the viewer.

Clause 14. The method of clause 13, where the screen viewing time includes a compiled viewing time associated with the viewer across a plurality of display devices in the secure device ecosystem.

Clause 15. The method of any of clauses 13 and 14, where the screen impact action includes a notification indicating a comparison between a screen viewing limit for the viewer and the adjusted screen viewing time.

Clause 16. The method of any of clauses 13, 14 and 15, where the screen impact action includes a notification including a screen viewing warning when the adjusted screen viewing time is above the screen viewing limit.

Clause 17. The method of any of clauses 13, 14, 15 and 16, where the screen impact action causes a blocked screen to be displayed on a display device of the at least one display device when the adjusted screen viewing time is above the screen viewing limit.

Clause 18. The method of any of clauses 13, 14, 15, 16 and 17, where the screen impact factor is generated using a viewer stress factor calculated from the sensor data associated with the viewer, where the sensor data includes biometric data for the viewer.

Clause 19. The method of any of clauses 13, 14, 15, 16, 17 and 18, where the screen impact factor is generated using an ambient environment factor calculated from the sensor data associated with the viewer, where the sensor data includes environmental data of a physical environment associated with the viewer during a screen viewing session.

Clause 20. The method of any of clauses 13, 14, 15, 16, 17, 18 and 19, where the screen viewing data includes a locally measured screen viewing time for the viewer, measured at a local display device of the at least one display device.

Clause 21. The method of any of clauses 13, 14, 15, 16, 17, 18, 19 and 20, where the sensor data includes a locally generated screen impact factor for the viewer, generated at a local sensor device of the at least one sensor device.

Clause 22. The method of any of clauses 13, 14, 15, 16, 17, 18, 19, 20 and 21, where the screen viewing data includes screen viewing data for a plurality of viewers, where the sensor data includes sensor data associated with the plurality of viewers, and where the method further includes: selecting screen viewing data associated with the viewer from the screen viewing data for the plurality of viewers; and selecting sensor data associated with the viewer from the sensor data associated with the plurality of viewers.

Clause 23. The method of any of clauses 13, 14, 15, 16, 17, 18, 19, 20, 21 and 22,where selecting screen viewing data associated with the viewer from the screen viewing data for the plurality of viewers further includes: identifying the viewer in the screen viewing data using facial recognition; and calculating a screen viewing time of the viewer using one or more of: a threshold view angle of the viewer, a threshold view distance of the viewer, and a minimum screen time of the viewer.

Clause 24. The method of any of clauses 13, 14, 15, 16, 17, 18, 19, 20, 21, 22 and 23,where the method further includes: identifying each other viewer of the plurality of viewers in the screen viewing data using facial recognition; and outputting a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a screen viewing time for the other viewer from the screen viewing data adjusted by the screen impact factor.

Clause 25. A non-transitory processor-readable storage medium including processor-readable instructions configured to cause one or more processors to perform screen impact monitoring, including code for:: receiving screen viewing data for a viewer from at least one display device in a secure device ecosystem including a screen viewing time for the viewer; and outputting a screen impact action for the viewer including an adjusted screen viewing time adjusted from the screen viewing time from the screen viewing data, where the screen viewing time is adjusted using a screen impact factor for the viewer generated from sensor data associated with the viewer to represent additional impacts of screen viewing on the viewer.

Clause 26. The non-transitory processor-readable storage medium of clause 25, where the screen viewing time includes a compiled viewing time associated with the viewer across a plurality of display devices in the secure device ecosystem.

Clause 27. The non-transitory processor-readable storage medium of any of clauses 25 and 26, where the screen impact action includes a notification indicating a comparison between a screen viewing limit for the viewer and the adjusted screen viewing time.

Clause 28. The non-transitory processor-readable storage medium of any of clauses 25, 26 and 27, where the screen impact action includes a notification including a screen viewing warning when the adjusted screen viewing time is above the screen viewing limit.

Clause 29. The non-transitory processor-readable storage medium of any of clauses 25, 26, 27 and 28, where the screen impact action causes a blocked screen to be displayed on a display device of the at least one display device when the adjusted screen viewing time is above the screen viewing limit.

Clause 30. The non-transitory processor-readable storage medium of any of clauses 25, 26, 27, 28 and 29, where the screen impact factor is generated using a viewer stress factor calculated from the sensor data associated with the viewer, where the sensor data includes biometric data for the viewer.

Clause 31. The non-transitory processor-readable storage medium of any of clauses 25, 26, 27, 28, 29 and 30, where the screen impact factor is generated using an ambient environment factor calculated from the sensor data associated with the viewer, where the sensor data includes environmental data of a physical environment associated with the viewer during a screen viewing session.

Clause 32. The non-transitory processor-readable storage medium of any of clauses 25, 26, 27, 28, 29, 30 and 31, where the screen viewing data includes a locally measured screen viewing time for the viewer, measured at a local display device of the at least one display device.

Clause 33. The non-transitory processor-readable storage medium of any of clauses 25, 26, 27, 28, 29, 30, 31 and 32, where the sensor data includes a locally generated screen impact factor for the viewer, generated at a local sensor device of the at least one sensor device.

Clause 34. The non-transitory processor-readable storage medium of any of clauses 25, 26, 27, 28, 29, 30, 31, 32 and 33, where the screen viewing data includes screen viewing data for a plurality of viewers, where the sensor data includes sensor data associated with the plurality of viewers, and further including code for: selecting screen viewing data associated with the viewer from the screen viewing data for the plurality of viewers; and selecting sensor data associated with the viewer from the sensor data associated with the plurality of viewers.

Clause 35. The non-transitory processor-readable storage medium of any of clauses 25, 26, 27, 28, 29, 30, 31, 32, 33 and 35, where selecting screen viewing data associated with the viewer from the screen viewing data for the plurality of viewers further includes: identifying the viewer in the screen viewing data using facial recognition; and calculating a screen viewing time of the viewer using one or more of: a threshold view angle of the viewer, a threshold view distance of the viewer, and a minimum screen time of the viewer.

Clause 36. The non-transitory processor-readable storage medium of any of clauses 25, 26, 27, 28, 29, 30, 31, 32, 33, 34 and 35, further including code for: identifying each other viewer of the plurality of viewers in the screen viewing data using facial recognition; and outputting a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a screen viewing time for the other viewer from the screen viewing data adjusted by the screen impact factor.

Clause 37. An apparatus for wireless communication, including: means for receiving screen viewing data for a viewer from at least one display device in a secure device ecosystem including a screen viewing time for the viewer; and means for outputting a screen impact action for the viewer including an adjusted screen viewing time adjusted from the screen viewing time from the screen viewing data, where the screen viewing time is adjusted using a screen impact factor for the viewer generated from sensor data associated with the viewer to represent additional impacts of screen viewing on the viewer.

Clause 38. The apparatus of clause 37, where the screen viewing time includes a compiled viewing time associated with the viewer across a plurality of display devices in the secure device ecosystem.

Clause 39. The apparatus of any of clauses 37 and 38, where the screen impact action includes a notification indicating a comparison between a screen viewing limit for the viewer and the adjusted screen viewing time.

Clause 40. The apparatus of any of clauses 37, 38 and 39, where the screen impact action includes a notification including a screen viewing warning when the adjusted screen viewing time is above the screen viewing limit.

Clause 41. The apparatus of any of clauses 37, 38, 39 and 40, where the screen impact action causes a blocked screen to be displayed on a display device of the at least one display device when the adjusted screen viewing time is above the screen viewing limit.

Clause 42. The apparatus of any of clauses 37, 38, 39, 40 and 41, where the screen impact factor is generated using a viewer stress factor calculated from the sensor data associated with the viewer, where the sensor data includes biometric data for the viewer.

Clause 43. The apparatus of any of clauses 37, 38, 39, 40, 41 and 42, where the screen impact factor is generated using an ambient environment factor calculated from the sensor data associated with the viewer, where the sensor data includes environmental data of a physical environment associated with the viewer during a screen viewing session.

Clause 44. The apparatus of any of clauses 37, 38, 39, 40, 41, 42 and 43, where the screen viewing data includes a locally measured screen viewing time for the viewer, measured at a local display device of the at least one display device.

Clause 45. The apparatus of any of clauses 37, 38, 39, 40, 41, 42, 43 and 44, where the sensor data includes a locally generated screen impact factor for the viewer, generated at a local sensor device of the at least one sensor device.

Clause 46. The apparatus of any of clauses 37, 38, 39, 40, 41, 42, 43, 44 and 45, where the screen viewing data includes screen viewing data for a plurality of viewers, where the sensor data includes sensor data associated with the plurality of viewers, and where the apparatus further includes: means for selecting screen viewing data associated with the viewer from the screen viewing data for the plurality of viewers; and means for selecting sensor data associated with the viewer from the sensor data associated with the plurality of viewers.

Clause 47. The apparatus of any of clauses 37, 38, 39, 40, 41, 42, 43, 44, 45, 46 and 47, where the means for selecting screen viewing data associated with the viewer from the screen viewing data for the plurality of viewers further includes: means for identifying the viewer in the screen viewing data using facial recognition; and means for calculating a screen viewing time of the viewer using one or more of: a threshold view angle of the viewer, a threshold view distance of the viewer, and a minimum screen time of the viewer.

Clause 48. The apparatus of any of clauses 37, 38, 39, 40, 41, 42, 43, 44, 45, 46, 47 and 48, where the apparatus further includes: means for identifying each other viewer of the plurality of viewers in the screen viewing data using facial recognition; and means for outputting a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a screen viewing time for the other viewer from the screen viewing data adjusted by the screen impact factor.

Clause 49. A device in a secure device ecosystem, including: a processing system that includes one or more processors and one or more memories coupled with the one or more processors, the processing system configured to cause the device to: receive local screen viewing data for a viewer at the device including a local screen viewing time for the viewer; and output a screen impact action for the viewer including an adjusted screen viewing time adjusted from the local screen viewing time from the local screen viewing data, where the local screen viewing time is adjusted using a screen impact factor for the viewer generated from sensor data associated with the viewer to represent additional impacts of screen viewing on the viewer.

Clause 50. The device of clause 49, where the screen impact action includes a notification indicating a comparison between a screen viewing limit for the viewer and the adjusted screen viewing time.

Clause 51. The device of any of clauses 49 and 50, where the screen impact action includes a notification including a screen viewing warning when the adjusted screen viewing time is above the screen viewing limit.

Clause 52. The device of any of clauses 49, 50, and 51, where the screen impact action causes a blocked screen to be displayed on a display associated with the device when the adjusted screen viewing time is above the screen viewing limit.

Clause 53. The device of any of clauses 49, 50, 51 and 52, where the screen impact factor is generated using a viewer stress factor calculated from the sensor data associated with the viewer, where the sensor data includes biometric data for the viewer.

Clause 54. The device of any of clauses 49, 50, 51, 52 and 53, where the screen impact factor is generated using an ambient environment factor calculated from the sensor data associated with the viewer, where the sensor data includes environmental data of a physical environment associated with the viewer during a screen viewing session.

Clause 55. The device of any of clauses 49, 50, 51, 52, 53 and 54, where the local screen viewing data includes a locally measured local screen viewing time for the viewer, measured at the device.

Clause 56. The device of any of clauses 49, 50, 51, 52, 53, 54 and 55, where the sensor data includes a locally generated screen impact factor for the viewer.

Clause 57. The device of any of clauses 49, 50, 51, 52, 53, 54, 55 and 56, where the local screen viewing data includes screen viewing data for a plurality of viewers, where the sensor data includes sensor data associated with the plurality of viewers, and where the processing system is configured to cause the device to: select local screen viewing data associated with the viewer from the local screen viewing data for the plurality of viewers; and select sensor data associated with the viewer from the sensor data associated with the plurality of viewers.

Clause 58. The device of any of clauses 49, 50, 51, 52, 53, 54, 55, 56 and 57, where selecting local screen viewing data associated with the viewer from the local screen viewing data for the plurality of viewers further includes: identifying the viewer in the local screen viewing data using facial recognition; and calculating a local screen viewing time of the viewer using one or more of: a threshold view angle of the viewer, a threshold view distance of the viewer, and a minimum screen time of the viewer.

Clause 59. The device of any of clauses 49, 50, 51, 52, 53, 54, 55, 56, 57 and 58, where the processing system is further configured to cause the device to: identify each other viewer of the plurality of viewers in the local screen viewing data using facial recognition; and output a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a local screen viewing time for the other viewer from the local screen viewing data adjusted by the screen impact factor.

Clause 60. A method for screen impact monitoring, the method including: receiving local screen viewing data for a viewer at a device in a secure device ecosystem including a local screen viewing time for the viewer; and outputting a screen impact action for the viewer including an adjusted screen viewing time adjusted from the local screen viewing time from the local screen viewing data, where the local screen viewing time is adjusted using a screen impact factor for the viewer generated from sensor data associated with the viewer to represent additional impacts of screen viewing on the viewer.

Clause 61. The method of clause 60, where the screen impact action includes a notification indicating a comparison between a screen viewing limit for the viewer and the adjusted screen viewing time.

Clause 62. The method of any of clauses 60 and 61, where the screen impact action includes a notification including a screen viewing warning when the adjusted screen viewing time is above the screen viewing limit.

Clause 63. The method of any of clauses 60, 61 and 62, where the screen impact action causes a blocked screen to be displayed on a display associated with the device when the adjusted screen viewing time is above the screen viewing limit.

Clause 64. The method of any of clauses 60, 61, 62 and 63, where the screen impact factor is generated using a viewer stress factor calculated from the sensor data associated with the viewer, where the sensor data includes biometric data for the viewer.

Clause 65. The method of any of clauses 60, 61, 62, 63 and 64, where the screen impact factor is generated using an ambient environment factor calculated from the sensor data associated with the viewer, where the sensor data includes environmental data of a physical environment associated with the viewer during a screen viewing session.

Clause 66. The method of any of clauses 60, 61, 62, 63, 64 and 65, where the local screen viewing data includes a locally measured local screen viewing time for the viewer, measured at the device.

Clause 67. The method of any of clauses 60, 61, 62, 63, 64, 65 and 66, where the sensor data includes a locally generated screen impact factor for the viewer.

Clause 68. The method of any of clauses 60, 61, 62, 63, 64, 65, 66 and 67, where the local screen viewing data includes local screen viewing data for a plurality of viewers, where the sensor data includes sensor data associated with the plurality of viewers, and where the method further includes: selecting local screen viewing data associated with the viewer from the local screen viewing data for the plurality of viewers; and selecting sensor data associated with the viewer from the sensor data associated with the plurality of viewers.

Clause 69. The method of any of clauses 60, 61, 62, 63, 64, 65, 66, 67 and 68, where selecting local screen viewing data associated with the viewer from the local screen viewing data for the plurality of viewers further includes: identifying the viewer in the local screen viewing data using facial recognition; and calculating a local screen viewing time of the viewer using one or more of: a threshold view angle of the viewer, a threshold view distance of the viewer, and a minimum screen time of the viewer.

Clause 70. The method of any of clauses 60, 61, 62, 63, 64, 65, 66, 67, 68 and 69, where the method further includes: identifying each other viewer of the plurality of viewers in the local screen viewing data using facial recognition; and outputting a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a local screen viewing time for the other viewer from the local screen viewing data adjusted by the screen impact factor.

Clause 71. A non-transitory processor-readable storage medium including processor-readable instructions configured to cause one or more processors to perform screen impact monitoring, including code for:: receiving local screen viewing data for a viewer at a device in a secure device ecosystem including a local screen viewing time for the viewer; and outputting a screen impact action for the viewer including an adjusted screen viewing time adjusted from the local screen viewing time from the local screen viewing data, where the local screen viewing time is adjusted using a screen impact factor for the viewer generated from sensor data associated with the viewer to represent additional impacts of screen viewing on the viewer.

Clause 72. The non-transitory processor-readable storage medium of clause 71, where the screen impact action includes a notification indicating a comparison between a screen viewing limit for the viewer and the adjusted screen viewing time.

Clause 73. The non-transitory processor-readable storage medium of any of clauses 71 and 72, where the screen impact action includes a notification including a screen viewing warning when the adjusted screen viewing time is above the screen viewing limit.

Clause 74. The non-transitory processor-readable storage medium of any of clauses 71, 72 and 73, where the screen impact action causes a blocked screen to be displayed on a display associated with the when the adjusted screen viewing time is above the screen viewing limit.

Clause 75. The non-transitory processor-readable storage medium of any of clauses 71, 72, 73 and 74, where the screen impact factor is generated using a viewer stress factor calculated from the sensor data associated with the viewer, where the sensor data includes biometric data for the viewer.

Clause 76. The non-transitory processor-readable storage medium of any of clauses 71, 72, 73, 74 and 75, where the screen impact factor is generated using an ambient environment factor calculated from the sensor data associated with the viewer, where the sensor data includes environmental data of a physical environment associated with the viewer during a screen viewing session.

Clause 77. The non-transitory processor-readable storage medium of any of clauses 71, 72, 73, 74, 75 and 76, where the local screen viewing data includes a locally measured local screen viewing time for the viewer, measured at the device.

Clause 78. The non-transitory processor-readable storage medium of any of clauses 71, 72, 73, 74, 75, 76 and 77, where the sensor data includes a locally generated screen impact factor for the viewer.

Clause 79. The non-transitory processor-readable storage medium of any of clauses 71, 72, 73, 74, 75, 76, 77 and 78, where the local screen viewing data includes local screen viewing data for a plurality of viewers, where the sensor data includes sensor data associated with the plurality of viewers, and further including code for: selecting local screen viewing data associated with the viewer from the local screen viewing data for the plurality of viewers; and selecting sensor data associated with the viewer from the sensor data associated with the plurality of viewers.

Clause 80. The non-transitory processor-readable storage medium of any of clauses 71, 72, 73, 74, 75, 76, 77, 78 and 35, where selecting local screen viewing data associated with the viewer from the local screen viewing data for the plurality of viewers further includes: identifying the viewer in the local screen viewing data using facial recognition; and calculating a local screen viewing time of the viewer using one or more of: a threshold view angle of the viewer, a threshold view distance of the viewer, and a minimum screen time of the viewer.

Clause 81. The non-transitory processor-readable storage medium of any of clauses 71, 72, 73, 74, 75, 76, 77, 78, 79 and 80, further including code for: identifying each other viewer of the plurality of viewers in the local screen viewing data using facial recognition; and outputting a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a local screen viewing time for the other viewer from the local screen viewing data adjusted by the screen impact factor.

Clause 82. An apparatus for wireless communication, including: means for receiving local screen viewing data for a viewer at a device in a secure device ecosystem including a local screen viewing time for the viewer; and means for outputting a screen impact action for the viewer including an adjusted screen viewing time adjusted from the local screen viewing time from the local screen viewing data, where the local screen viewing time is adjusted using a screen impact factor for the viewer generated from sensor data associated with the viewer to represent additional impacts of screen viewing on the viewer..

Clause 83. The apparatus of clause 82, where the screen impact action includes a notification indicating a comparison between a screen viewing limit for the viewer and the adjusted screen viewing time.

Clause 84. The apparatus of any of clauses 82 and 83, where the screen impact action includes a notification including a screen viewing warning when the adjusted screen viewing time is above the screen viewing limit.

Clause 85. The apparatus of any of clauses 82, 83 and 84, where the screen impact action causes a blocked screen to be displayed on a display associated with the device when the adjusted screen viewing time is above the screen viewing limit.

Clause 86. The apparatus of any of clauses 82, 83, 84 and 85, where the screen impact factor is generated using a viewer stress factor calculated from the sensor data associated with the viewer, where the sensor data includes biometric data for the viewer.

Clause 87. The apparatus of any of clauses 82, 83, 84, 85 and 86, where the screen impact factor is generated using an ambient environment factor calculated from the sensor data associated with the viewer, where the sensor data includes environmental data of a physical environment associated with the viewer during a screen viewing session.

Clause 88. The apparatus of any of clauses 82, 83, 84, 85, 86 and 87, where the local screen viewing data includes a locally measured local screen viewing time for the viewer, measured at the device.

Clause 89. The apparatus of any of clauses 82, 83, 84, 85, 86, 87 and 88, where the sensor data includes a locally generated screen impact factor for the viewer.

Clause 90. The apparatus of any of clauses 82, 83, 84, 85, 86, 87, 88 and 89, where the local screen viewing data includes local screen viewing data for a plurality of viewers, where the sensor data includes sensor data associated with the plurality of viewers, and where the apparatus further includes: means for selecting local screen viewing data associated with the viewer from the local screen viewing data for the plurality of viewers; and means for selecting sensor data associated with the viewer from the sensor data associated with the plurality of viewers.

Clause 91. The apparatus of any of clauses 82, 83, 84, 85, 86, 87, 88, 89, 89 and 90, where the means for selecting local screen viewing data associated with the viewer from the local screen viewing data for the plurality of viewers further includes: means for identifying the viewer in the local screen viewing data using facial recognition; and means for calculating a local screen viewing time of the viewer using one or more of: a threshold view angle of the viewer, a threshold view distance of the viewer, and a minimum screen time of the viewer.

Clause 92. The apparatus of any of clauses 82, 83, 84, 85, 86, 87, 88, 89, 89, 90 and 91, where the apparatus further includes: means for identifying each other viewer of the plurality of viewers in the local screen viewing data using facial recognition; and means for outputting a screen impact action for each respective other viewer of the plurality of viewers, where the screen impact action for each respective other viewer is generated using: a screen impact factor for the other viewer generated from the sensor data associated with the other viewer, and an adjusted screen viewing time for the other viewer including a local screen viewing time for the other viewer from the local screen viewing data adjusted by the screen impact factor.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A network device in a secure device ecosystem, comprising:
a processing system that includes one or more processors and one or more memories coupled with the one or more processors, the processing system configured to cause the network device to:
receive screen viewing data for a viewer from at least one display device in the secure device ecosystem comprising a screen viewing time for the viewer; and
output a screen impact action for the viewer comprising an adjusted screen viewing time adjusted from the screen viewing time from the screen viewing data,
where the screen viewing time is adjusted using a screen impact factor for the viewer generated from sensor data associated with the viewer to represent additional impacts of screen viewing on the viewer.

2. The network device of claim 1, wherein the screen viewing time comprises a compiled viewing time associated with the viewer across a plurality of display devices in the secure device ecosystem.

3. The network device of claim 1, wherein the screen impact action comprises a notification indicating a comparison between a screen viewing limit for the viewer and the adjusted screen viewing time.

4. The network device of claim 3, wherein the screen impact action comprises a notification including a screen viewing warning when the adjusted screen viewing time is above the screen viewing limit.

5. The network device of claim 3, wherein the screen impact action causes a blocked screen to be displayed on a display device of the at least one display device when the adjusted screen viewing time is above the screen viewing limit.

6. The network device of claim 1, wherein the screen impact factor is generated using a viewer stress factor calculated from the sensor data associated with the viewer, wherein the sensor data comprises biometric data for the viewer.

7. The network device of claim 1, wherein the screen impact factor is generated using an ambient environment factor calculated from the sensor data associated with the viewer, wherein the sensor data comprises environmental data of a physical environment associated with the viewer during a screen viewing session.

8. The network device of claim 1, wherein the screen viewing data comprises a locally measured screen viewing time for the viewer, measured at a local display device of the at least one display device.

9. The network device of claim 1, wherein the sensor data comprises a locally generated screen impact factor for the viewer, generated at a local sensor device of the at least one sensor device.

10. The network device of claim 1, wherein the screen viewing data comprises screen viewing data for a plurality of viewers, wherein the sensor data comprises sensor data associated with the plurality of viewers, and wherein the processing system is further configured to cause the network device to:
select screen viewing data associated with the viewer from the screen viewing data for the plurality of viewers; and
select sensor data associated with the viewer from the sensor data associated with the plurality of viewers.

11. The network device of claim 10, wherein selecting screen viewing data associated with the viewer from the screen viewing data for the plurality of viewers further comprises:
identifying the viewer in the screen viewing data using facial recognition; and
calculating a screen viewing time of the viewer using one or more of:
a threshold view angle of the viewer,
a threshold view distance of the viewer, and
a minimum screen time of the viewer.

12. The network device of claim 10, wherein the processing system is further configured to cause the network device to:
identify each other viewer of the plurality of viewers in the screen viewing data using facial recognition; and
output a screen impact action for each respective other viewer of the plurality of viewers,
where the screen impact action for each respective other viewer is generated using:
a screen impact factor for the other viewer generated from the sensor data associated with the other viewer, and
an adjusted screen viewing time for the other viewer comprising a screen viewing time for the other viewer from the screen viewing data adjusted by the screen impact factor.

13. A device in a secure device ecosystem, comprising:
a processing system that includes one or more processors and one or more memories coupled with the one or more processors, the processing system configured to cause the device to:
receive local screen viewing data for a viewer at the device comprising a local screen viewing time for the viewer; and
output a screen impact action for the viewer comprising an adjusted screen viewing time adjusted from the local screen viewing time from the local screen viewing data,
where the local screen viewing time is adjusted using a screen impact factor for the viewer generated from sensor data associated with the viewer to represent additional impacts of screen viewing on the viewer.

14. A method for screen impact monitoring, comprising:
receiving screen viewing data for a viewer from at least one display device in a secure device ecosystem comprising a screen viewing time for the viewer; and
outputting a screen impact action for the viewer comprising an adjusted screen viewing time adjusted from the screen viewing time from the screen viewing data,
where the screen viewing time is adjusted using a screen impact factor for the viewer generated from sensor data associated with the viewer to represent additional impacts of screen viewing on the viewer.

15. The method of claim 14, wherein the screen viewing time comprises a compiled viewing time associated with the viewer across a plurality of display devices in the secure device ecosystem.

16. The method of claim 14, wherein the screen impact action comprises at least one of:
a notification indicating a comparison between a screen viewing limit for the viewer and the adjusted screen viewing time, and
a notification including a screen viewing warning when the adjusted screen viewing time is above the screen viewing limit.

17. The method of claim 14, wherein the screen impact factor is generated using at least one of:
a viewer stress factor calculated from the sensor data associated with the viewer, wherein the sensor data comprises biometric data for the viewer, and
an ambient environment factor calculated from the sensor data associated with the viewer, wherein the sensor data comprises environmental data of a physical environment associated with the viewer during a screen viewing session.

18. The method of claim 14, wherein the screen viewing data comprises a locally measured screen viewing time for the viewer, measured at a local display device of the at least one display device, and wherein the sensor data comprises a locally generated screen impact factor for the viewer, generated at a local sensor device of the at least one sensor device.

19. The method of claim 14, wherein the screen viewing data comprises screen viewing data for a plurality of viewers, wherein the sensor data comprises sensor data associated with the plurality of viewers, and wherein the method further comprises:
selecting screen viewing data associated with the viewer from the screen viewing data for the plurality of viewers; and
selecting sensor data associated with the viewer from the sensor data associated with the plurality of viewers.

20. The method of claim 19, wherein selecting screen viewing data associated with the viewer from the screen viewing data for the plurality of viewers further comprises:
identifying the viewer in the screen viewing data using facial recognition; and
calculating a screen viewing time of the viewer using one or more of:
a threshold view angle of the viewer,
a threshold view distance of the viewer, and
a minimum screen time of the viewer.
